(19) United States
(12) Patent Application Publication
(10) Pub. No.: US 2025/0110726 A1
(43) Pub. Date: Apr. 3, 2025

(54) METHOD, DEVICE, AND COMPUTER PROGRAM PRODUCT FOR UPGRADING VIRTUAL SYSTEM

(71) Applicant: Dell Products L.P., Round Rock, TX (US)

(72) Inventors: Bing Liu, Tianjin (CN); Simin Wang, Beijing (CN)

(21) Appl. No.: 18/531,508

(22) Filed: Dec. 6, 2023

(30) Foreign Application Priority Data
Sep. 28, 2023 (CN) 202311289953.X

(51) Int. Cl. G06F 8/65; G06F 9/455

(52) U.S. Cl. CPC G06F 8/65; G06F 9/45558; G06F 2009/45595

(57) ABSTRACT

Upgrade of a virtual system is described. An example method includes recording access data of the virtual system that uses a cloud service, and in response to receiving an attribute set of a group of candidate cloud services, determining a predicted mode of the workload of the virtual system based on the access data. An upgrade preference is determined for the virtual system based on the access data and/or user settings of the virtual system. A cloud service for upgrading the virtual system is selected from the group of candidate cloud services based on the predicted mode and the upgrade preference, and a recommendation report is generated indicating the cloud service. Personalized cloud service recommendations can be created according to access habits of a user for the virtual system and other, user desired performance aspects so that upgrading the virtual system with the recommended cloud service improves user experience.

### RELATED APPLICATION

The present application claims the benefit of priority to Chinese Patent Application No. 202311289953.X, filed on Sep. 28, 2023, which application is hereby incorporated into the present application by reference herein in its entirety.

### TECHNICAL FIELD

Embodiments of the present disclosure relate to virtualization technologies and, more particularly, to a method, a device, and a computer program product for upgrading a virtual system.

### BACKGROUND

With the rapid development of cloud-based technologies, more and more users migrate their electronic business to a virtual system hosted by one or more cloud platforms. The resources needed to run these virtual systems need not be managed and maintained by users themselves, but rather can be provided by one or more cloud providers in the form of cloud services.

Cloud providers can provide virtual machine (VM) services of various specifications with different computing capabilities for users to create VM instances running virtual systems. Cloud providers can also provide various types and sizes of cloud storage services for users to choose data storage for virtual systems. Users can subscribe to or purchase the required cloud services to create, maintain, or upgrade their own virtual systems.

### SUMMARY

Example embodiments of the present disclosure provide a solution for upgrading a virtual system.

In a first example embodiment of the present disclosure, a method for upgrading a virtual system is provided, including: recording access data of the virtual system that uses a cloud service; in response to receiving an attribute set of a group of candidate cloud services, determining a predicted mode of the workload of the virtual system based on the access data; determining an upgrade preference for the virtual system based on at least one of the access data and user settings of the virtual system; selecting a cloud service for upgrading the virtual system from the group of candidate cloud services based on the predicted mode and the upgrade preference; and generating a recommendation report indicating the selected cloud service.

In a second example embodiment of the present disclosure, an electronic device is provided, including a processor and a memory coupled to the processor having instructions stored therein that, when executed by the processor, cause the device to perform actions including: recording access data of the virtual system that uses a cloud service; in response to receiving an attribute set of a group of candidate cloud services, determining a predicted mode of the workload of the virtual system based on the access data; determining an upgrade preference for the virtual system based on at least one of the access data and user settings of the virtual system; selecting a cloud service for upgrading the virtual system from the group of candidate cloud services based on the predicted mode and the upgrade preference; and generating a recommendation report indicating the selected cloud service.

In a third example embodiment of the present disclosure, a computer program product is provided. The computer program product is tangibly stored on a computer-readable medium and includes machine-executable instructions that, when executed, cause a machine to perform the method according to the first aspect of the present disclosure.

It should be noted that this Summary is provided to introduce a selection of concepts in a simplified manner. These concepts will be further described in the Detailed Description below. The Summary is neither intended to identify key features or major features of the present disclosure, nor intended to limit the scope of the present disclosure.

### BRIEF DESCRIPTION OF THE DRAWINGS

By further detailed description of example embodiments of the present disclosure with reference to the accompanying drawings, the above and other objectives, features, and advantages of the present disclosure will become more apparent, in which:

FIG. 1 illustrates a schematic diagram of an example environment in which multiple embodiments of the present disclosure can be implemented;

FIG. 2 illustrates a flow chart of an example method for upgrading a virtual system according to some embodiments of the present disclosure;

FIG. 3 illustrates a flow chart of an example method for upgrading a virtual system according to some embodiments of the present disclosure;

FIG. 4 illustrates a visualized schematic diagram of a predicted mode of the workload of a virtual system determined according to some embodiments of the present disclosure;

FIG. 5 illustrates an example architecture for upgrading a virtual system according to some embodiments of the present disclosure; and

FIG. 6 illustrates a schematic block diagram of a device that can be used to implement embodiments of the present disclosure.

Throughout all the drawings, the same or similar reference numerals represent the same or similar elements.

### DETAILED DESCRIPTION

The embodiments of the present disclosure will be described below in further detail with reference to the accompanying drawings. Although the accompanying drawings illustrate certain embodiments of the present disclosure, it should be understood that the present disclosure can be implemented in various forms and should not be explained as being limited by the embodiments described herein. Instead, these embodiments are provided to enable a more thorough and complete understanding of the present disclosure.

The term “include” and its variants as used herein mean open-ended inclusion, i.e., “including but not limited to.” The term “based on” means “based at least in part on.” The term “an embodiment” means “at least one embodiment.” The term “another embodiment” indicates “at least one additional embodiment.” Relevant definitions of other terms will be given in the description below.

When deploying a virtual system on a cloud, a user can choose a cloud service that provides various system resources for the virtual system according to his/her business needs and workload, such as providing the series/model of the virtual machine with the required computing power and providing the specification of the cloud disk with the required storage space. The cloud services used by the same virtual system can be supplied by multiple cloud providers, and the underlying physical resources running these cloud services can be distributed at different geographical locations.

By using cloud services to deploy the virtual system, the user can focus on his/her core business without paying attention to the maintenance of the underlying resources. During the operation of the virtual system, the cloud provider may release a new series or version of cloud service over time. The user of the virtual system can subscribe to notifications, so as to be pushed with relevant messages when a new cloud service is released and decide whether to upgrade related resources of the virtual system to the new cloud service (for example, migrate to a new VM instance, etc.). However, simple message pushing cannot enable the user to efficiently identify from the upgrade information the cloud service that meets his/her upgrade requirements, for example, the cloud service that can improve the particular performance metrics that he/she is concerned about and/or meet his/her security requirements.

The operation and maintenance engineers of some virtual systems continuously monitor the latest cloud services released by the cloud providers and test them to release recommended cloud services to customers. In the test, an operation and maintenance engineer usually needs to create a test instance using the new cloud service and a comparison instance of the similar cloud service currently used by the virtual system. The operation and maintenance engineer can test the network and file system performance of the two instances, and recommend the corresponding cloud service to the user when the test instance performs better. Conventional recommendation methods based on testing tend to recommend cloud services with stronger capabilities during operation, while ignoring users' actual usage habits and business requirements for the virtual system.

To at least partially address the above and other potential problems, embodiments of the present disclosure propose a solution for upgrading a virtual system. This solution records access data of the virtual system that uses a cloud service during operation, and determines a predicted mode of the subsequent workload of the virtual system based on the recorded access data when receiving an attribute set of candidate cloud services that can be recommended. Further, this solution determines the upgrade preference for the virtual system based on at least one of the access data and user settings of the virtual system. On this basis, this solution selects a cloud service for upgrading the virtual system from the candidate cloud services based on the predicted mode and the upgrade preference and generates a recommendation report indicating the selected cloud service.

With this solution, a personalized cloud service recommendation can be made according to the access habits of a user for the virtual system and the performance aspects that the user is concerned about. The recommendation report is generated for a specific virtual system, and upgrading the virtual system by using the cloud server recommended therein can improve the performance aspects of the specific system that the user is concerned about and meet his/her performance restrictions and requirements. Therefore, the upgrade of the virtual system can better meet the use habits and demands of the user, thus improving the user experience.

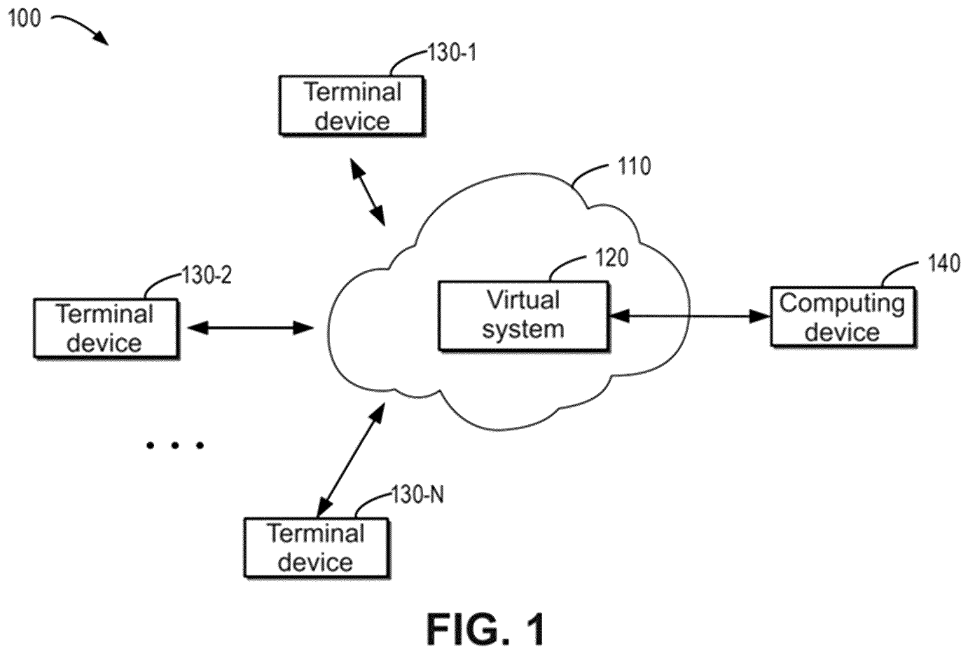

FIG. 1 shows a schematic diagram of an example environment 100 in which multiple embodiments of the present disclosure can be implemented. As shown in FIG. 1, the environment 100 may include a cloud 110. The cloud 110 includes various system resources provided by multiple cloud providers (not shown). These systems can be provided in the form of cloud services on multiple cloud platforms, such as virtual machine services that provide computing resources and cloud disk services that provide cloud storage. A cloud provider can regularly or irregularly update the provided cloud services and release update information, such as the attributes of new cloud services.

Enterprise or individual users can subscribe to and/or purchase the required cloud services according to their own business demands. After obtaining the right to use the required cloud services, a user can create a group of instances of cloud services (such as a combination of a virtual machine and a cloud disk with specific configurations) on the cloud 110 and deploy his/her virtual system on these instances to run business online.

For example, the environment 100 includes a virtual system 120 deployed on the cloud 110. It should be understood that the virtual system 120 is shown as a single logical entity for convenience of explanation, but due to the characteristics of a cloud, the underlying physical resources of the cloud services used by the virtual system 120 can be deployed at different physical locations. In addition, the cloud services used by the virtual system 120 can be provided by providers of multiple cloud services.

Various users of the virtual system 120 can access the virtual system 120 through multiple terminal devices 130-1, 130-2, . . . , and 130-N (individually or collectively referred to as terminal devices 130) to read and write the virtual system 120, request the virtual system 120 to perform a certain computing function, and so on. For example, a user can request to write data into the cloud storage space of the virtual system 120 from a local device or another device through the terminal device 130, or download data from the cloud storage space of the virtual system 120 to a local device or another device. The terminal device 130 can be implemented as any suitable form of fixed or mobile electronic device, such as a desktop computer, a smartphone, a tablet computer, a wearable device, and the like.

FIG. 1 also shows a computing device 140, which can communicate with other entities in the environment 100 and can perform various actions according to embodiments of the present disclosure. For example, the cloud provider can update its cloud services regularly or irregularly, and release various attributes about the updated cloud services. The computing device 140 can actively (e.g., by listening) or passively (e.g., by subscribing) obtain the update information of the cloud provider. For example, by using the method according to the embodiments of the present disclosure, the computing device 140 can directly, or instruct the virtual system 120 to, record the access data of the virtual system 120, determine the predicted access mode and user upgrade preference for the virtual system 120, generate cloud service recommendations for the virtual system 120, and so on. For convenience of explanation, description will be made herein in the context where the computing device 140 performs corresponding actions.

Although the computing device 140 is shown as a single entity in FIG. 1, the computing device 140 may exist and be distributed in any suitable form in various embodiments. As a non-limiting example, the computing device 140 may be a computing device of an operation and maintenance party. The operation and maintenance party can act as an intermediary between cloud providers and users to assist multiple users to deploy and maintain multiple virtual systems. The computing device 140 may also be a device of a cloud provider that also provides relevant recommendation functions. The computing device 140 itself may also be a virtual device deployed on the cloud 110, and the scope of the present disclosure is not limited in this respect.

The architecture and functions in the example environment 100 are described for illustrative purposes only, without implying any limitation to the scope of the present disclosure. There may also be other devices, systems, or components that are not shown in the example environment 100. For example, multiple virtual systems other than the virtual system 120 may also be deployed on the cloud 110, and the computing device 140 can perform recommendations for other virtual devices. Furthermore, the embodiments of the present disclosure may also be applied to other environments having different structures and/or functions.

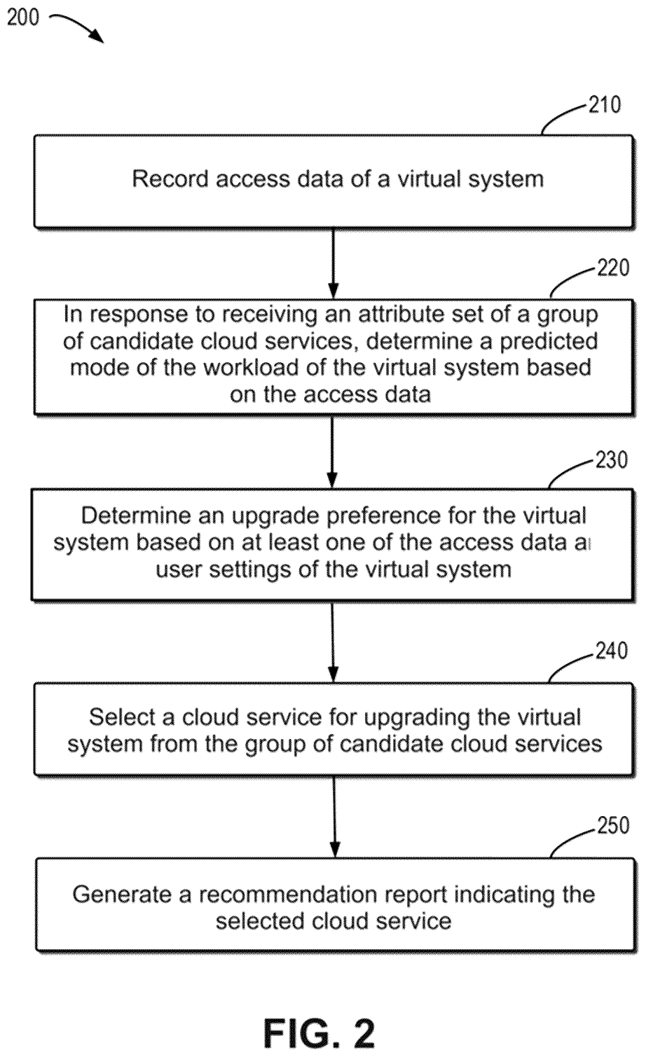

FIG. 2 illustrates a flow chart of an example method 200 for upgrading a virtual system according to some embodiments of the present disclosure. For example, the example method 200 may be performed by the computing device 140 shown in FIG. 1. It should be understood that the method 200 may also include additional actions not shown, and the scope of the present disclosure is not limited in this regard. The method 200 is described in detail below in conjunction with the example environment 100 of FIG. 1.

At 210, access data of a virtual system that uses a cloud service is recorded. For example, the computing device 140 can record the access data of the virtual system 120. In some embodiments, the computing device 140 can directly monitor user access to the virtual system 120 and record the access data. In some embodiments, the virtual system 120 itself can record an access log, and the computing device 140 can obtain from the virtual system 120 its access log regularly or on demand for recording.

In some embodiments, the computing device 140 can record one or more pieces of the following access data: the login IP address of the user accessing the virtual system 120, and the source IP address and the destination IP address of the data traffic generated during the access to the virtual system 120 (for example, the upload, download, and migration of data, the transmission of computation results, etc.). Thus, the computing device 140 can learn the distribution of various geographical locations associated with the user access to the virtual system 120.

In some embodiments, the computing device 140 can record the occurrence time of read/write (I/O) operations generated during the access to the virtual system 120 as the access data. Thus, the computing device 140 can learn the historical read-write I/O mode for the virtual system 120.

At 220, in response to receiving an attribute set of a group of candidate cloud services, a predicted mode of the workload of the virtual system is determined based on the access data. For example, the computing device 140 can determine a predicted mode of the workload of the virtual system 120 based on the access data recorded at 210 in response to receiving the attribute set of the group of candidate cloud services.

In some embodiments, the computing device 140 can receive an attribute set of a group of candidate cloud services from update information released by one or more cloud providers. In response to receiving the attribute set, the computing device 140 can determine the predicted mode of the workload of the virtual system 120, thereby starting the process of cloud service recommendation.

The attribute set of the cloud service may include indication of resources that the cloud service can provide. For example, the candidate cloud service may be a specific type of virtual machine services, and its attribute set can include the number of virtual central processing units (vCPUs), memory size, maximum throughput/bandwidth, available area of disk IOPS, price, and the like of this type of virtual machines. For example, the candidate cloud service may be a cloud storage service, and its attribute set may include cloud disk type (for example, SSD), maximum capacity, maximum throughput, maximum IOPS, price, and the like.

In some embodiments, based on the access data of the virtual system 120, the computing device 140 may use a machine learning model to perform prediction, thereby identifying a predicted access mode of the virtual system 120 in a future period. For example, the machine learning model may be a regression model such as a regression random forest model. This predicted access mode is determined based on historical access data, so it generally reflects access habits of a user for the virtual system 120.

In some embodiments, the predicted mode includes the geographical location distribution associated with future traffic of the virtual system 120, such as the expected distribution of login locations of users, and/or the expected distribution of source locations and destination locations of the traffic of the virtual system 120, and the like. The computing device 140 may perform such prediction based on the corresponding IP address in the recorded access data.

In some embodiments, the predicted mode includes an expected I/O mode of a user for the virtual system, for example, the time when future I/O operations occur. Similarly, the computing device 140 can perform such prediction based on historical I/O records.

At 230, an upgrade preference for the virtual system is determined based on at least one of the access data and user settings of the virtual system. For example, the computing device 140 may determine an upgrade preference for the virtual system 120 based on at least one of the access data recorded at 220 and the user settings of the virtual system 120.

In some embodiments, the determined upgrade preference may indicate one or more performance metrics of the virtual system 120. The one or more performance metrics reflect the aspects that the user of the virtual system 120 is concerned about. For example, the performance metric may indicate that the user is concerned about the service latency of the virtual system 120. For example, the performance metric may indicate that the user of the virtual system 120 is price-sensitive. In some embodiments, the upgrade preference also includes restrictions on upgrade of the virtual system 120, such as restrictions on the geographical location where the cloud service is deployed.

At 240, a cloud service for upgrading the virtual system is selected from the group of candidate cloud services based on the predicted mode and the upgrade preference. For example, the computing device 140 can select a cloud service for upgrading the virtual system 120 from the group of candidate cloud services at 220 based on the predicted mode determined at 220 and the upgrade preference determined at 230.

In some embodiments, for a cloud service among the group of candidate cloud services, the computing device 140 can determine, based on the attribute set of the cloud service and the predicted mode of the workload of the virtual system 120, an expected value of a performance metric indicated in the upgrade preference when using the cloud service for the virtual system 120. If the expected value is better than the current expected value of the corresponding performance metric without upgrading, the computing device 140 may select the cloud service as a recommendation.

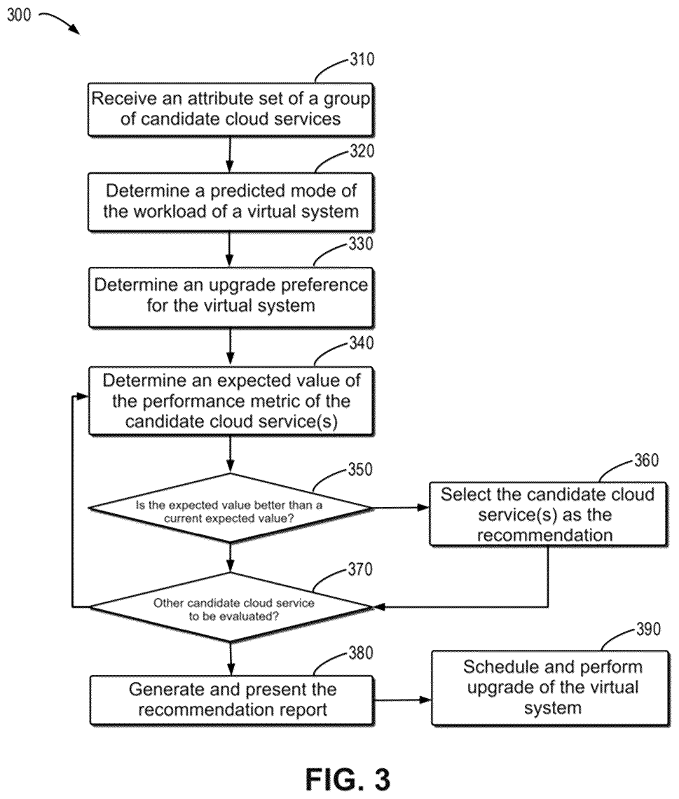

For example, the computing device 140 can determine the expected charge (e.g., monthly charge, charge of unit data volume, etc.) when the candidate cloud storage service is used for the virtual system 120 based on the predicted read/write mode of the user to the virtual system 120 and the unit price (e.g., the price each time, the price per 10,000 times, etc.) of the read/write operation on the candidate cloud storage service. The determination of the predicted mode and upgrade preference and the selection of the cloud service for upgrade will be described in further detail later in conjunction with FIG. 3.

At 250, a recommendation report indicating the selected cloud service is generated. For example, the computing device 140 may generate a recommendation report for the virtual system 120, which indicates the cloud service selected at 240. For example, the recommendation report may include the name, version number, and/or recommended parameters of the selected candidate cloud service. The generated recommendation report can be pushed to an administrator user of the virtual system 120 for subsequent upgrade decision and guidance, as will be described in detail later in conjunction with FIG. 3.

With the method 200, a personalized cloud service recommendation can be made according to the access mode of a user to a specific virtual system and the performance aspects that the user is concerned about, thus improving the recommendation quality. The virtual system upgrade based on this recommendation can better meet the usage habits and demands of the user, thus improving the user experience.

FIG. 3 illustrates a flow chart of an example method 300 for upgrading a virtual system according to some embodiments of the present disclosure. The example method 300 may be performed, for example, by the device 140 shown in FIG. 1. It should be understood that the method 300 may also include additional actions not shown, some actions in the method 300 may be omitted, and the scope of the present disclosure is not limited in this respect. Moreover, the actions in the method 300 are not necessarily performed in the illustrated order. The method 300 is described in detail below in conjunction with the example environment 100 of FIG. 1.

At 310, the computing device 140 can receive an attribute set of a group of candidate cloud services. The computing device 140 may actively or passively receive an attribute set of available cloud services from multiple cloud providers. For example, the computing device 140 can extract newly released cloud service update information from pages of one or more cloud providers regularly or according to instructions. For example, the computing device 140 can subscribe to update notifications from one or more cloud providers, and receive a newly released attribute set of available cloud services from a cloud service provider due to the subscription (e.g., by mail).

In response to receiving an attribute set of a group of candidate cloud services, the computing device 140 can start a recommendation process. At 320, the computing device 140 can determine a predicted mode of the workload of the virtual system 120 based on the access data. As described above with respect to 210, the computing device 140 can record the access data of the virtual system 120. In some embodiments, when a recommendation needs to be made, the computing device 140 can use the access data of the most recent period (for example, the past week, month, or year) to perform prediction. In some embodiments, the computing device 140 can use an appropriate machine learning model (e.g., some kind of regression model) to determine the predicted mode from the access data.

In some embodiments, the computing device 140 can predict the distribution of geographic locations associated with the traffic of the virtual system 120 based on the corresponding IP address in the access data. The distribution of geographic locations may be, for example, an expected distribution of login locations of users and/or an expected distribution of source and destination locations of the traffic of the virtual system 120. In some embodiments, the computing device 140 can predict the expected distribution of I/O occurrence times for the virtual system 120 in a future period based on the historical I/O records in the access data. The predicted mode is determined based on historical access behaviors of users, which reflect possible characteristics of future access of a user to the virtual system 120.

At 330, the computing device 140 can determine an upgrade preference for the virtual system 120 based on at least one of the access and the user settings of the virtual system 120. The upgrade preference may indicate one or more performance metrics about which the user of the virtual system 120 is concerned. When upgrading the virtual system 120, the one or more performance metrics should be optimized first.

In some embodiments, the computing device 140 can record the upgrade actions of the user for the virtual system 120, such as the model and configuration of the cloud service selected for the update, as the access data. Thus, the computing device 140 can learn the historical upgrade decisions of users of the virtual system 120, and identify the users' upgrade preference therefrom. For example, the computing device 140 can identify that the user prefers to choose a low-priced cloud service. Therefore, expected charge can be used as a performance metric in the upgrade preference. In some embodiments, the computing device 140 can also determine that the user is price-sensitive through the tag set by the user, and thus take the expected charge as a performance metric that should be optimized in the upgrade preference.

In some embodiments, the computing device 140 can identify that the user of the virtual system 120 tends to choose a cloud service with shorter latency and take the latency as a performance metric to be optimized according to one or more of: access data indicating that there is frequent real-time interactive traffic in the virtual system 120; or a tag set by the user indicating that the virtual system 120 is applied to a latency-sensitive field, such as online games, electronic shopping, and the like. In some embodiments, the computing device 140 may indicate that the virtual system 120 is applied to high-throughput fields such as data backup and video download based on the user tags or the access data, and take bandwidth as a performance metric to be optimized.

In some embodiments, the computing device 140 can determine that the user prefers to utilize cloud services deployed as close as possible to a certain country and/or region based on the geographical location distribution indicated in the access data, for example, based on user login and data read/write in the virtual system 120 all occurring in this country and/or region.

In some embodiments, the upgrade preference also includes restrictions on upgrade of the virtual system 120, such as restrictions on the geographical location where the cloud service to be used is deployed. In some embodiments, the computing device 140 can determine that the user has high requirements for the security of the virtual system 120 according to one or more of: the user having enabled functions related to high security in the settings of the virtual system 120, such as encryption function, or the tag set by the user indicating that the virtual system 120 is applied to security-sensitive fields, such as finance, government business, and the like. Furthermore, the computing device 140 can determine a specific area where the cloud service of the virtual system 120 should be deployed based on the access data or the geographical location where the business of the virtual system 120 occurs as indicated in the user settings, and include it in the determined upgrade preference.

In an embodiment where the upgrade preference includes restrictions on the geographical location (for example, it must be deployed in a certain region due to security), the computing device 140 can determine whether the deployment location of the candidate cloud service meets the geographical location restrictions, and it is possible to continue evaluating a candidate cloud service as a potential recommendation only if the candidate cloud service meets the restrictions.

At 340, for the candidate cloud service(s) in a group of candidate cloud services, the computing device 140 can determine an expected value of the performance metric indicated by the performance preference when using the candidate cloud service(s) for the virtual system 120. The computing device 140 can determine the expected value based on the predicted mode and the attribute set of the candidate cloud services.

In a non-limiting example, the upgrade preference for the virtual system 120 indicates that the unit charge of its workload should be optimized, and the candidate cloud service is the Object Storage Service (OSS). Operations in OSS can be realized by calling OSS Application Programming Interface (API) operations, and the charge thereof can be calculated according to the number of API calls or the volume of data.

API read requests may include, for example, PUT, COPY, POST, UPLOAD, RESTORE, and DELETE requests. The API write requests may include, for example, GET, HEAD, and SELECT requests. The unit prices of a read request and a write request of the same storage service calling API can be different. It should be understood that the object storage service is only shown as an example. In the embodiments of the present disclosure, the reads and writes supported by the storage service may be chunk-based storage or object-based storage, and the computing device 140 can select a candidate storage service from services of multiple providers.

In this example, according to the predicted mode of the workload of the virtual system 120, the workload of the virtual system 120 will include 80% reads and 20% writes. Moreover, among the candidate cloud services, there is a storage service of version Y, and its attribute set indicates that the reading price using this service is 5 currency units/Gb and the writing price is 0.2 currency units/Gb. On this basis, the computing device 140 can determine that if the storage service of version Y is used, the expected unit charge of the virtual system 120 is 80%*5 currency units/Gb+20%*2 currency units/Gb=4.4 currency units/Gb.

In some embodiments, the computing device 140 can recommend a combination of multiple candidate cloud services of different types (e.g., a specific combination of virtual machine service and cloud storage service) for upgrading. In such embodiment, the computing device 140 can determine an expected value of one or more performance metrics indicated in the upgrade preference when such combination is used for the virtual system 120.

Then, at 350, the computing device 140 can determine whether the expected value determined at 340 is better than the current expected value of the corresponding performance metric without upgrading the virtual system 120. Continue with the above example describing the candidate storage service. In this example, the virtual system 120 is using version X storage service, with a reading price of 10 currency units/Gb and a writing price of 0.5 currency units/Gb. Therefore, if the virtual system 120 is not upgraded, its current expected unit charge is 80%*10 currency units/Gb+20%*0.5 currency units/Gb=8.1 currency units/Gb. If the virtual system 120 is upgraded to use version Y storage service, the use price of this specific virtual system 120 will be significantly reduced, which conforms to the upgrade preference of the user of the virtual system 120.

In this way, the computing device 140 can make more personalized recommendations for different workload modes and upgrade preferences. For example, among the first candidate service deployed in region A with high price and the second candidate service of the same type deployed in region B with low price, the computing device 140 can choose to recommend the first candidate service to security-sensitive users whose business is located in region A, and recommend the second candidate service to price-sensitive users to upgrade their virtual systems.

In some embodiments, recommendations determined for different performance metrics may conflict with each other. For example, recommendations that improve latency may increase costs. When determining the upgrade preference, the weight of the performance metric can also be determined. The weight reflects the relative importance of the corresponding performance among the concerned performances. Further, the computing device 140 may take the weight into consideration when determining whether the expected value is better. For example, the computing device 140 may calculate a weighted sum of the values of the various metrics and compare the sum of the weighted expected values with the sum of the current weighted expected values without upgrading.

In some embodiments, when recommending cloud services, the computing device 140 can also determine whether the recommended cloud services are compatible with each other in the geographic aspect and the functional aspect, and whether the recommended cloud services and the rest of the cloud services reserved by the virtual system 120 are compatible with each other in the geographic aspect and the functional aspect. For example, Object Service Storage (OSS) buckets created in different regions may not be able to communicate through the intranet, which hinders the use of the virtual system 120. If the virtual system 120 uses multiple cloud storage services, the computing device 140 may only recommend cloud storage services that are deployed in the same area as the rest of the cloud storage services of the virtual system 120.

If it is determined that the expected value is better than the current expected value without upgrade, the method 300 may proceed to 360, where the computing system 140 can select the candidate cloud service(s) currently being processed (i.e., a single cloud service or a combination of cloud services) as a recommendation. In the above example of cloud storage service, the computing device 140 can select the storage service of the version Y as a recommendation. The method 300 then proceeds to 370. If it is determined at 360 that the expected value is not better than the current expected value, the method 300 may proceed directly to 370.

The computing device 140 may determine at 370 whether there is a candidate cloud service to be evaluated, that is, another candidate cloud service or another combination of candidate cloud services. If so, the method 300 returns to 340 to continue to determine whether to recommend the other candidate cloud service or another combination. Otherwise, the computing device 140 completes the selection, and the method 300 proceeds to 380.

At 380, the computing device 140 may generate a recommendation report indicating the selected cloud service and present the report to the user. In some embodiments, the recommendation report can also include description of how the selected cloud service meets the upgrade preference of the user. For example, the computing device 140 can list the performance metrics that the selected cloud service can improve in the recommendation report.

In some embodiments, the computing device 140 can generate a user-readable natural language report. For example, after recommending a cloud service that can reduce the usage charge of the virtual system for a price-sensitive user, the computing device can generate a recommendation report similar to “Example X.X.X will reduce your monthly average charge for using the system by Y %.”

In some embodiments, the computing device 140 may include multiple recommendations that meet the upgrade preference in the recommendation report for the user to make a final upgrade decision later. In some embodiments, the computing device 140 may further select an optimal recommendation from the multiple recommendations that meet the upgrade preference and include it in the recommendation report.

In some embodiments, an administrator user of the virtual system 120 can log in on the terminal 130. The computing device 140 can thus push the recommendation report to the terminal 130 to display the report on the display of the terminal 130. In some embodiments, the administrator user can instruct the computing device 140 to perform an upgrade based on the recommendation report. For example, the administrator user can click the displayed “Confirm Upgrade” button to cause the terminal 130 to send an upgrade instruction to the computing device 140. For example, the administrator user can select a cloud service that is finally used for the upgrade from the recommended multiple cloud services in the displayed recommendation report.

In response to receiving an instruction to perform an upgrade based on the recommendation report, the computing device 140 can schedule and perform an upgrade of the virtual system 120 at 390 to upgrade the corresponding type of cloud service currently used by the virtual system 120 to the recommended candidate cloud service. For example, the computing device 140 can migrate the virtual system 120 to the virtual machine instance of the recommended version, and/or update the storage device of the virtual machine 140 to the recommended cloud disk specification, and so on.

In some embodiments, the computing device 140 can schedule the upgrade of the virtual system 120 based on a previously determined predicted mode of the workload of the virtual system 120. For example, the computing device 140 can schedule the upgrade of the virtual system 120 in the period when the workload of the virtual system 120 is expected to be the smallest, that is, the idlest period. For example, the computing device 140 can schedule upgrades in batches and determine the portion of upgrades of each batch. When scheduling the upgrade, the predicted mode of workload is taken into account, and the upgrade is performed in a way that is expected to have the least impact on the business of the virtual system 120, so that the impact on the user experience caused by the interruption that may be brought about by the upgrade operation can be reduced as much as possible.

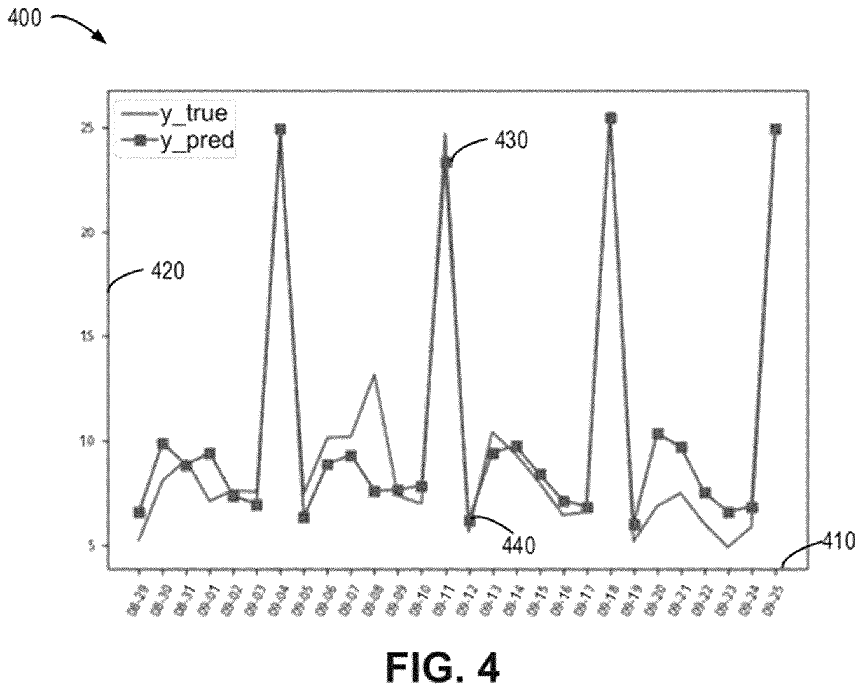

Refer now to FIG. 4. FIG. 4 illustrates a schematic diagram 400 determined according to some embodiments of the present disclosure, which shows the visualization of an example predicted mode of the workload of the virtual system. The schematic diagram 400 reflects the variation over time of the predicted value of the disk usage rate of the virtual system determined based on the access data.

In FIG. 4, the horizontal axis 410 indicates the date, and the vertical axis 420 indicates the predicted value of the disk usage rate. In this example, the predicted value is determined by the computing device 140 based on the access data of the virtual system using a random forest model, and is represented by the curve y_pred in FIG. 4. For comparison,

FIG. 4 also illustrates the true value of the disk usage rate subsequently detected for the virtual system, which is represented by the curve y_true. It can be seen from the comparison between the predicted value and the true value that the computing device 140 can well predict the subsequent usage of the virtual system.

According to the prediction shown in FIG. 4, the disk utilization rate of the virtual system presents a weekly peak, for example, at the time point indicated by the reference numeral 430. For example, this may be caused by the weekly backup operation of the virtual system 140. After that, the disk utilization rate of the virtual system will drop rapidly and enter a relatively idle period. Therefore, the computing device 140 can schedule the upgrade of the virtual system in the period when the virtual system is the idlest, for example, near the time point indicated by reference numeral 440. In this way, the computing device 140 can determine an upgrade schedule suitable for a specific virtual system as opposed to assuming a common idle period to perform an upgrade.

After the upgrade is completed, the computing device 140 may also continue to perform the method 300 to perform the next upgrade if necessary. By using the method 300, personalized cloud service recommendations are made according to the access mode of the specific virtual system and the performance aspects that the user is concerned about, according to which an upgrade is performed, and the upgraded virtual system can be optimized in the performance aspects that the user is concerned about, thereby improving the user experience. Moreover, there is no need to actually run test instances for such recommendation, thus saving the testing overhead.

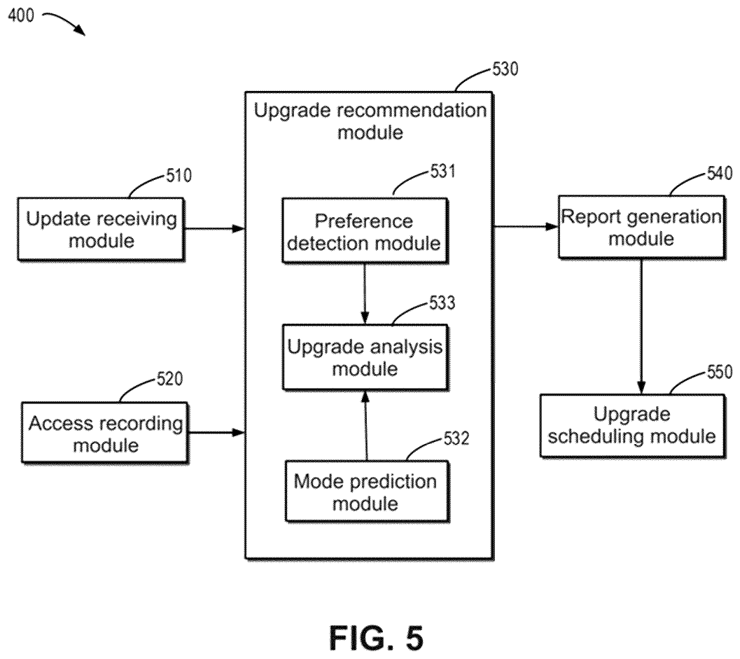

FIG. 5 shows an example architecture 500 for upgrading a virtual system according to some embodiments of the present disclosure, which may be an example implementation of logic modules in the computing device 140 for upgrading a virtual system (e.g., the virtual system 120) according to the method (e.g., the methods 200 and 300) of the embodiments of the present disclosure. FIG. 5 is described below with reference to the example environment 100 of FIG. 1. It should be understood that some modules in the architecture 500 may be omitted, and there may be other modules not shown in the device 140. Furthermore, the architecture 500 is only an example, and other suitable architectures capable of implementing the solution described in the present disclosure can also be used.

The architecture 500 may include an update receiving module 510 and an access recording module 520. During the operation of the virtual system 120, the computing device 140 can use the update receiving module 510 to actively or passively receive an attribute set of candidate cloud services, and use the access recording module 520 to directly or indirectly record the access data of the virtual system 120, as described above.

The update receiving module 510 can monitor the updates of cloud services, so that the computing device 140 can make update recommendations for the user in time. The update receiving module 510 may take the available cloud services for which it has received the attribute set as recommended candidates, or preliminarily screen out the cloud services that obviously do not meet the upgrade requirements from the available cloud services based on the attribute set of the cloud services, for example, the virtual machine service whose CPU speed does not meet the minimum requirement of the Service Level Agreement (SLA) associated with the virtual system 120.

The architecture 500 may also include an upgrade recommendation module 530, which may include multiple sub-modules, such as a preference detection module 531, a mode prediction module 532, and an upgrade analysis module 533. In response to the update receiving module 510 receiving a group of candidate cloud services, the computing device 140 can use the preference detection module 531 to determine the upgrade preference for the virtual system 120. The upgrade preference can be determined based on at least one of the access data recorded by the access recording module 510 and the user settings of the virtual system 120.

Furthermore, the computing device 140 can use the mode prediction module 532 to determine a predicted mode of the workload of the virtual system 120. The mode prediction module 532 can implement a machine learning model such as a regression model, and take the access data recorded by the access recording module 520 as the data to determine the predicted mode of the workload.

Based on the determined predicted mode and the upgrade preference, the upgrade analysis module 533 can select a recommended cloud service for upgrading the virtual system 120 from the candidate cloud services. The analysis module 533 can calculate based on the attribute set of candidate cloud services and the predicted mode to determine an expected value of the performance metric indicated in the upgrade preference, and select the recommended cloud service accordingly, as described in detail above with respect to FIGS. 2 to 3.

Based on the recommended cloud service selected by the upgrade recommendation module 530, the computing device 140 can use a report generation module 540 to generate a recommendation report and present it to the administrator user of the virtual system 120. The architecture 500 may also include an upgrade scheduling module 550. For example, the upgrade scheduling module may receive from the terminal device 130 an instruction to upgrade the virtual system 120 based on the recommendation report. In response to the instruction, the upgrade scheduling module can schedule the upgrade of the virtual system 120, such as arranging an upgrade schedule, based on the predicted mode of the workload of the virtual system 120.

Individual modules of the architecture 500 can perform the above actions according to the methods described above with respect to FIGS. 2-4, and description thereof will not be repeated here. The architecture 500 provides a virtual system upgrade framework integrating multiple functional modules, which can provide timely and personalized upgrade recommendations for the virtual system conforming with usage modes and user preferences thereof.

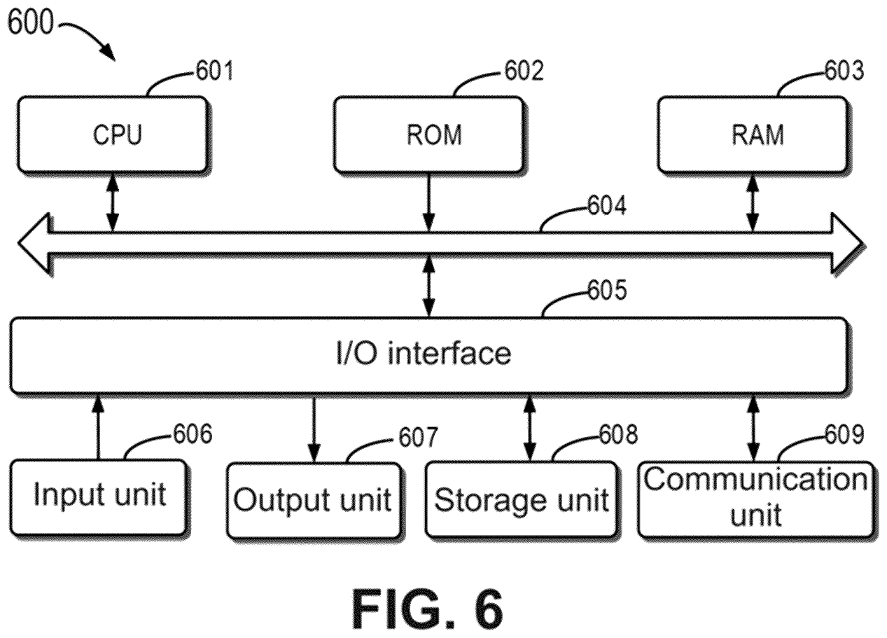

FIG. 6 illustrates a schematic block diagram of a device 600 that may be used to implement embodiments of the present disclosure. The device 600 may be a device or apparatus as described in embodiments of the present disclosure. As shown in FIG. 6, the device 600 includes a central processing unit (CPU) 601 that can perform various appropriate actions and processing according to computer program instructions stored in a read-only memory (ROM) 602 or computer program instructions loaded from a storage unit 608 to a random access memory (RAM) 603. Various programs and data required for the operation of the device 600 may also be stored in the RAM 603. The CPU 601, the ROM 602, and the RAM 603 are connected to one another via a bus 604. An input/output (I/O) interface 605 is also connected to the bus 604. Although not shown in FIG. 6, the device 600 may also include a co-processor.

A plurality of components in the device 600 are connected to the I/O interface 605, and include: an input unit 606, such as a keyboard, a mouse, or the like; an output unit 607, such as various types of displays, speakers, or the like; a storage unit 608, such as a magnetic disk, an optical disc, or the like; and a communication unit 609, such as a network card, a modem, a wireless communication transceiver, or the like. The communication unit 609 allows the device 600 to exchange information/data with other devices via a computer network, such as the Internet, and/or various telecommunication networks.

The various methods or processes described above may be performed by the processing unit 601. For example, in some embodiments, the methods can be implemented as a computer software program that is tangibly included in a machine-readable medium such as the storage unit 608. In some embodiments, part of or all the computer program may be loaded and/or installed onto the device 600 via the ROM 602 and/or the communication unit 609. When the computer program is loaded onto the RAM 603 and executed by the CPU 601, one or more steps or actions of the methods or processes described above may be performed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may maintain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, state setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored therein includes an article of manufacture that includes instructions that implement various aspects of the functions/actions specified in one or more blocks in the flow charts and/or block diagrams.

The computer-readable program instructions may also be loaded to a computer, other programmable data processing apparatuses, or other devices, so that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, and the module, program segment, or part of an instruction includes one or more executable instructions for implementing specified logical functions. In some alternative implementations, functions denoted in the blocks may also occur in an order different from that denoted in the accompanying drawings. For example, two successive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented using a special-purpose hardware-based system that executes specified functions or actions, or using a combination of special-purpose hardware and computer instructions.

The embodiments of the present disclosure have been described above. The foregoing description is illustrative rather than exhaustive, and is not limited to the embodiments disclosed. Numerous modifications and alterations are apparent to those of ordinary skill in the art without departing from the scope and spirit of the illustrated embodiments. The selection of terms as used herein is intended to best explain the principles and practical applications of the various embodiments or the technical improvements to technologies on the market, or to enable other people of ordinary skill in the art to understand the various embodiments disclosed herein.

What is claimed is:

1. A method, comprising:
recording, by a system comprising at least one processor, access data of a virtual system that is to be upgraded and that uses a cloud service;
in response to receiving an attribute set of a group of candidate cloud services, determining a predicted mode of the workload of the virtual system based on the access data;
determining an upgrade preference for the virtual system based on at least one of the access data and user settings of the virtual system;
selecting a cloud service usable to upgrade the virtual system from the group of candidate cloud services based on the predicted mode and the upgrade preference, the selecting resulting in a selected cloud service; and
generating a recommendation report indicating the selected cloud service.

2. The method according to claim 1, wherein the upgrade preference indicates one or more performance metrics of the virtual system, and wherein selecting the cloud service usable to upgrade the virtual system comprises:
for a candidate cloud service in the group of candidate cloud services, determining a first expected value of the one or more performance metrics when the candidate cloud service is used for the virtual system based on the predicted mode and the attribute set;
determining, based on the predicted mode, a current expected value of the one or more performance metrics without upgrading; and
selecting the candidate cloud service in response to determining that the expected value is better than the current expected value according to a defined performance criterion.

3. The method according to claim 2, wherein selecting the candidate cloud service comprises:
determining a second expected value of the one or more performance metrics when a combination of multiple candidate cloud services of different types is used for the virtual system; and
selecting the combination in response to the second expected value of the combination being better than the current expected value according to the defined performance criterion.

4. The method according to claim 2, wherein the upgrade preference further comprises one or more weights of the one or more performance metrics, and wherein the determining that the expected value is better than the current expected value comprises:
determining that the expected value is better than the current expected value based on the one or more weights.

5. The method according to claim 1, further comprising:
in response to receiving an instruction to upgrade the virtual system based on the recommendation report, scheduling the upgrade of the virtual system based on the predicted mode.

6. The method according to claim 1, wherein determining the predicted mode comprises identifying an expected distribution of geographical locations associated with traffic of the virtual system, and selecting the cloud service usable to upgrade the virtual system comprises:
for a candidate cloud service in the group of candidate cloud services, determining a first expected service latency of the virtual system when the candidate cloud service is used for the virtual system based on the expected distribution and the attribute set; and
in response to determining that the first expected service latency is less than a second expected service latency of the virtual system without upgrading, selecting the candidate cloud service.

7. The method according to claim 1, wherein determining the predicted mode comprises identifying an expected read/write mode corresponding to a user of the virtual system, and selecting the cloud service usable to upgrade the virtual system comprises:
for a candidate cloud service in the group of candidate cloud services, determining a first expected unit charge of the virtual system when the candidate cloud service is used for the virtual system based on the expected read/write mode and the attribute set; and
in response to determining that the first expected unit charge is lower than a second expected unit charge of the virtual system without upgrading, selecting the candidate cloud service.

8. The method according to claim 1, wherein the upgrade preference comprises geographical location restrictions, and selecting the cloud service usable to upgrade the virtual system from the group of candidate cloud services comprises:
determining whether a deployment location of the cloud service satisfies the geographical location restrictions.

9. A device, comprising:
a processor; and
a memory coupled with the processor, the memory having instructions stored therein that, when executed by the processor, cause the device to perform actions comprising:
recording access data of a virtual system that uses a cloud service;
in response to receiving an attribute set of a group of candidate cloud services, determining a predicted mode of the workload of the virtual system based on the access data;
determining an upgrade preference for the virtual system based on at least one of the access data and user settings of the virtual system;
selecting a cloud service configured to upgrade the virtual system from the group of candidate cloud services based on the predicted mode and the upgrade preference, the selecting resulting in a selected cloud service; and
generating a recommendation report indicating the selected cloud service.

10. The device according to claim 9, wherein the upgrade preference indicates one or more performance metrics of the virtual system, and selecting the cloud service configured to upgrade the virtual system comprises:
for a candidate cloud service in the group of candidate cloud services, determining a first expected value of the one or more performance metrics when the candidate cloud service is used for the virtual system based on the predicted mode and the attribute set; and
determining, based on the predicted mode, a current expected value of the one or more performance metrics without upgrading the virtual system;
selecting the candidate cloud service in response to determining that the first expected value is better than the current expected value.

11. The device according to claim 10, wherein selecting the candidate cloud service comprises:
determining a second expected value of the one or more performance metrics when a combination of multiple candidate cloud services of different types is used for the virtual system; and
selecting the combination in response to the second expected value of the combination being determined to be representative of a higher value than the current expected value.

12. The device according to claim 10, wherein the upgrade preference further comprises one or more weights of the one or more performance metrics, and wherein the determining that the expected value is better than the current expected value comprises:
determining that the expected value is better than the current expected value based on a weight of the one or more weights.

13. The device according to claim 9, wherein the actions further comprise:
in response to receiving an instruction to upgrade the virtual system based on the recommendation report, scheduling the upgrade of the virtual system based on the predicted mode.

14. The device according to claim 9, wherein determining the predicted mode comprises identifying an expected distribution of geographical locations associated with traffic of the virtual system, and selecting the cloud service configured to upgrade the virtual system comprises:
for a candidate cloud service in the group of candidate cloud services, determining a first expected service latency of the virtual system when the candidate cloud service is used for the virtual system based on the expected distribution and the attribute set; and
in response to determining that the first expected service latency is less than a second expected service latency of the virtual system without upgrading, selecting the candidate cloud service.

15. The device according to claim 9, wherein determining the predicted mode comprises identifying an expected read/write mode of a user for the virtual system, and wherein selecting the cloud service configured to upgrade the virtual system comprises:
for a candidate cloud service in the group of candidate cloud services, determining a first expected unit charge of the virtual system when the candidate cloud service is used for the virtual system based on the expected read/write mode and the attribute set; and
in response to determining that the first expected unit charge is lower than a second expected unit charge of the virtual system without upgrading, selecting the candidate cloud service.

16. The device according to claim 9, wherein the upgrade preference comprises geographical location restrictions, and selecting the cloud service configured to upgrade the virtual system from the group of candidate cloud services comprises:
determining whether a deployment location of the cloud service satisfies the geographical location restrictions.

17. A computer program product stored on a non-transitory computer-readable medium and comprising machine-executable instructions that, when executed, cause a machine to perform operations comprising:
recording access data of a virtual system that uses a cloud service;
in response to receiving an attribute set of a group of candidate cloud services, determining a predicted mode of the workload of the virtual system based on the access data;
determining an upgrade preference for the virtual system based on at least one of the access data and a user setting of the virtual system;
selecting a cloud service for upgrade of the virtual system from the group of candidate cloud services based on the predicted mode and the upgrade preference, the selecting resulting in a selected cloud service; and
generating a recommendation report indicating the selected cloud service.

18. The computer program product according to claim 17, wherein the upgrade preference indicates one or more performance metrics of the virtual system, and selecting the cloud service for upgrading the virtual system comprises:
for a candidate cloud service in the group of candidate cloud services, determining a first expected value as a function of the one or more performance metrics when the candidate cloud service is used for the virtual system based on the predicted mode and the attribute set; and
determining, based on the predicted mode, a current expected value of the one or more performance metrics without upgrading the virtual system;
selecting the candidate cloud service in response to determining that the first expected value is greater than the current expected value.

19. The computer program product according to claim 18, wherein selecting the candidate cloud service comprises:
determining a second expected value of the one or more performance metrics when a combination of multiple candidate cloud services of different types is used for the virtual system; and
selecting the combination in response to determining that the second expected value of the combination being greater than the current expected value.

20. The computer program product according to claim 18, wherein the upgrade preference further comprises a weight associated with the one or more performance metrics, and determining that the expected value is greater than the current expected value comprises:
determining that the expected value is greater than the current expected value based on the weight.
